(19) United States
(12) Patent Application Publication
(10) Pub. No.: US 2020/0355617 A1
(43) Pub. Date: Nov. 12, 2020

(54) TEXTILE WITH OPTICAL DYES FOR SENSING FLUID-BORNE ANALYTES

(71) Applicant: Trustees of Tufts College, Medford, MA (US)

(72) Inventors: Sameer Sonkusale, Lincoln, MA (US); Rachel Owyeung, Medford, MA (US)

(21) Appl. No.: 16/765,937

(22) PCT Filed: Sep. 27, 2018
(86) PCT No.: PCT/US2018/053058

§ 371 Date: May 21, 2020

Related U.S. Application Data
(60) Provisional application No. 62/590,846, filed on Nov. 27, 2017.

(51) Int. Cl. G01N 21/78; G01N 31/22

(52) U.S. Cl. CPC G01N 21/78; G01N 31/22

(57) ABSTRACT

A wearable sensor has threads that are coated with a polymer coating. Each thread has an optically-responsive chemical dye entrapped thereon. Each of the dyes is selected emit electromagnetic radiation upon exposure to a selected analyte.

### CROSS-REFERENCE TO RELATED APPLICATIONS

This application claims the benefit of U.S. Provisional Application No. 62/590,846, filed Nov. 27, 2017, all of which is incorporated herein by reference.

### FIELD OF INVENTION

The invention relates to textiles, and in particular, to sensory textiles.

### BACKGROUND

The detection of analytes present in the environment is essential for applications regarding health, food spoilage or allergens, and public and workplace safety. Known ways to detect such analytes include electrochemical detection of analyte oxidation and optical detection of chemically-responsive materials.

Electrochemical sensors measure a quantifiable electrical signal induced by the physical adsorption of a chemical analyte onto a receptor's surface. However, due to their reliance on physical adsorption for signal generation, electrical sensors are prone to humidity and signal drift.

Optical sensing relies on a light source interacting with the target sample and the ability to capture a response. Although optical sensing avoids the difficulties encountered by electrochemical sensor, this method requires a suitable light source.

### SUMMARY

In one aspect, the invention features an apparatus comprising a wearable sensor whose colors change in response to exposure to a particular fluid-borne analyte, which is either a fluid, such as a gas or liquid, or a constituent of a fluid. Such a wearable sensor includes threads coated with a polymer coating. Each of the threads has an optically-responsive chemical dye entrapped thereon. These dyes are selected to change color upon exposure to the particular analyte whose presence is to be detected.

The threads themselves can be made from a variety of materials. In some embodiments, the threads are made of a natural fiber. Examples of suitable natural fibers include cotton, silk, and wool. In other embodiments, the threads are made of synthetic fibers. Examples of suitable synthetic fibers include polyacrylonitrile, polyamide, polyurethane, polyethylene and polyether-polyurea copolymer.

Any of a variety of dyes can be entrapped in the thread. Examples of such dues include metalloporphyrin, any of various metal salts, acid and base indicators, and any of various vapochromic substances.

Also among the embodiments are those in which the thread has been treated with an aqueous wash comprising a weak acid or a weak base. Examples of weak acids include acetic acid, citric acid, oxalic acid, and formic acid. Examples of weak bases include methylamine and pyridine.

A variety of polymer coatings can be used, including an encapsulating matrix that coats the threads, thereby entrapping the dyes. An example of such a matrix is one made of chitosan.

In some embodiments, the polymer coating comprises a fluid-permeable polymer. Among these are coatings that comprise gas-permeable polymers and those that comprise liquid-permeable polymers. Also among the embodiments are those in which the polymer coating comprises silicone, those in which it comprises polyurethane polymer chains, those in which it includes a hydrophobic region, those in which it is intrinsically hydrophobic, and those in which it has been treated to be hydrophobic.

A wearable sensor according to the invention is able to detect any of a variety of analytes depending on the particular choice of a dye. Examples of analytes that can be detected include ammonia, sulfur oxide, nitrogen oxide, and hydrogen chloride, whether dissolved in liquid or in gaseous form. Examples of a liquid would include a liquid that includes the analyte as a dissolved gas or a liquid that contains the analyte as a constituent thereof. Examples include ammonium hydroxide, hydrogen chloride, acetone, or benzene, all in liquid form.

In some embodiments, different threads have different dyes. This results in a sensor array that can detect different kinds of analytes at the same time in much the same way that a spectrum indicates the existence of many substances in parallel.

Embodiments include those m which the threads are formed into a sensing patch to be sewn on a garment.

Yet other embodiments include a garment, wherein the threads are formed into a sensing patch to be sewn on the garment. Alternatively, the sensing patch can be sewn to a watch strap, a belt, a sock, a handbag, a wallet, and a handkerchief. Or, the sensing patch can be placed on a wall or ceiling.

In some embodiments, the wearable sensor, when washed, retains its sensing functionality.

Also among the embodiments are those that include a consumer device with software-based color extraction such as a smart phone, a web camera, or a flat-bed scanner.

In another aspect, the invention features the use of a textile thread or yarn as a substrate for a low-cost wearable diagnostic platform. The wearable diagnostic platform as described herein provides stable entrapment of optically-responsive dyes using polymer matrices, such as chitosan and polydimethylsiloxane matrices. This provides the basis for a detection system that can be integrated into clothing.

The method and systems described herein are inherently modular in design. As a result, it is possible to easily manufacture the wearable diagnostic platform using different types of dye molecules and different quantities of dye molecules. This makes it possible to chemically sense a broad array of analytes. By entrapping the dye molecules, the matrix improves the sensor's stability and robustness.

A suitable material for use in forming the matrix is chitosan. Chitosan is an abundant biopolymer that is water soluble at low pH values. This permits the matrix to be formed without the use of harsh solvents. Moreover, chitosan's bacteriostatic properties make it ideal for wearable devices.

Incorporated within the threads is an array of chemically-responsive dyes to sense and distinguish between volatile organic compounds, including those that may be present in explosives. In this way, the invention finds use in anti-terrorist activity.

The use of a dye array mimics the operation of a typical biological olfactory system. In such a system, specificity in smell detection arises from pattern recognition of responses of many cross-reactive olfactory receptors. As such, the dye array can be regarded as an optoelectronic-nose array.

Dyes that are suitable for optoelectronic nose arrays include Bronsted acidic or basic dyes, Lewis acidic or basic dyes, redox-responsive dyes, or dyes with large permanent dipoles including solvatochromic or zwitterionic dyes. Bronsted acidic or basic dyes, commonly pH indicators, are sensitive in specific pH ranges. Lewis acid or basic dyes, such as metalloporphyrins are sensitive to electron-pair acceptors and donors, such as amines, sulfates, and highly conjugated pi-pi systems. Solvatochromic or zwitterionic dyes respond to changes in polarity or hydrogen bonding of the surrounding environment.

Threads offer certain advantages for use as substrates. They are flexible and have favorable wicking properties. Unlike paper-based substrates, threads conveniently provide a three-dimensional scaffold and thus offer more surface area per unit volume for use in making analytical measurements. The high surface-area to volume ratio inherent in the use of threads permits greater sensitivity in a smaller package.

Other advantages of threads include the fact that they can be interwoven and used for sewing and suturing. They can also be tailored to have different physical properties such as hydrophobicity, hydrophilicity, elasticity, strength, and inertness.

A thread-based wearable sensor as described herein permits environmental monitoring of ammonia, ethanol, and pH changes from 4.4 to 7.6.

Some embodiments use a metalloporphyrin, 5,10,15,20-Tetraphenyl-21H,23H-porphine manganese(III) chloride, and two pH indicator dyes, methyl red and bromothymol blue.

Embodiments that use thread for optical detection of gaseous analytes include those in which the thread is a robust thread, i.e., one that can withstand repeated washings in a washing machine. Suitable thread materials include natural fibers such as cellulose, cotton, silk, and wool. Other thread materials include synthetic fibers, such as polyacrylonitrile, polyamides (nylon), polyester, polyethylene (PET), polyurethane, polyether-polyurea copolymers, and Spandex.

This technique is adaptable to entrap a wider range of dye molecules than existing methods. These dye types include metalloporphyrins, acid indicators, base indicators, vapochromic, and metal salts.

The process begins with forming a dye solution by using a solvent such as ethanol, water, or toluene.

Once the dye solution is created, the threads are soaked in the solution until they are fully wicked.

The threads are then moved to a secondary treatment phase in which a weak acid or base, depending on dye type, is used to promote a more favorable electrostatic interaction that will more firmly entrap the dye. A suitable acid for use in this process would be acetic acid.

Following the secondary treatment, the threads are dried and coated in a thin layer of a coating polymer that is both hydrophobic and gas-permeable. Examples include as polydimethylsiloxane, other silicones, other elastomers, and polyurethanes.

A particularly suitable coating is a dual-matrix coating. In such cases, each coating can contribute a desirable property that the other coating lacks. For example, the outer coating could be made antibacterial and the inner coating could be elastomeric, or vice versa. By suitably choosing the coatings, it is possible to make a stable, hydrophobic, and elastic biocompatible thread. In some embodiments, there is a chitosan inner matrix and a polydimethylsiloxane outer matrix. The polymer coating is then cured. At this point, the thread is ready to be incorporated as a wearable sensor.

These and other features of the invention will be apparent from the following detailed description and the accompanying figures, in which:

### BRIEF DESCRIPTION OF THE DRAWINGS

FIG. 1 shows an analyte-detection system; and

FIG. 2 shows an apparatus for manufacturing the thread used in the analyte-detection system of FIG. 1.

### DETAILED DESCRIPTION

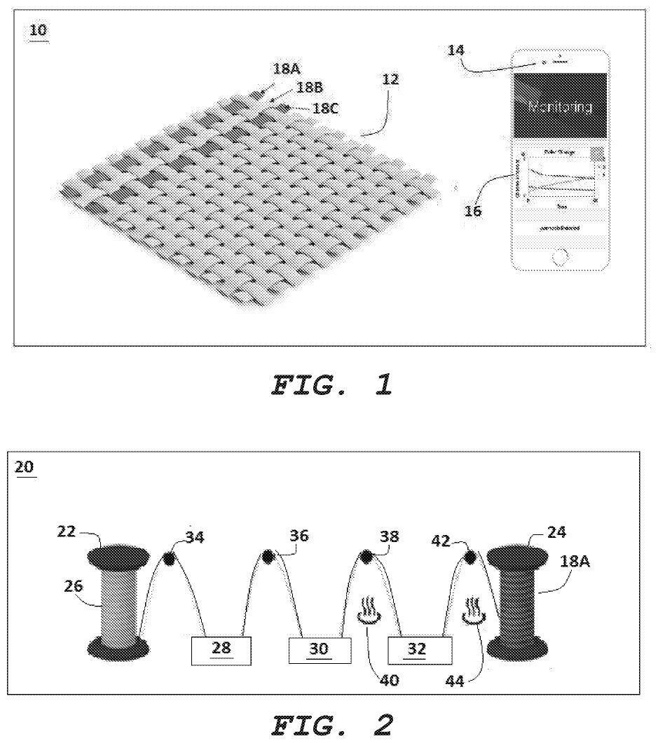

FIG. 1 shows an analyte-detection system 10 that includes a sensor 12 and a camera 14 connected to an image processor 16.

The camera 14 and image processor 14 are of the type that are available on a common smart phone. The camera 14 and processor 14 cooperate to determine when a particular color is present.

The sensor 12 comprises threads 18A, 18B, 18C, or equivalently, yarns, that have been woven together. The threads 18A, 18B, 18C have been processed with reagents so that they will change color in the presence of particular fluid-borne analytes. In the illustrated embodiment, there are three kinds of threads, each of which has been treated with a different reagent. As a result, it is possible to detect different kinds of analytes at the same time. However, it is possible to have only one kind of thread 18A or to have more than three kinds of threads.

To detect the presence of an analyte, one points the camera 14 in the general direction of the sensor 12 and activates the image processor 16 so that it monitors the color of the sensor 12. If fluid containing the analyte contacts the sensor 12, an interaction between the analyte and the reagent creates a perceptible color change in one or more of the threads 18A, 18B, 18C. The image processor 16 detects this change and indicates the presence of the corresponding one or more analytes.

Referring to FIG. 2, a manufacturing apparatus 20 for manufacturing thread to be woven into the sensor 12 features an initial spool 22 and a final spool 24. The initial spool 22 holds unfinished thread 26. The final spool 22 holds finished thread 18A.

Between the initial and final spools 22, 24 is a sequence of baths, rollers, and driers. In the illustrated embodiment, the sequence has first, second, and third baths 28, 30, 32, first, second, third, and fourth rollers 34, 36, 38, 42 and first and second driers 40, 44.

A first roller 34 is between the first bath 28 and the initial spool 22. A second roller 36 is between the first and second baths 28, 30. A third roller 38 and the first drier 40 are between the second and third baths 30, 32. A fourth roller 42 and a second drier 44 are between the third bath 32 and the final spool 24.

The process of manufacturing a thread 18A includes causing stable entrapment of an optically-sensitive dye onto the unfinished thread 26. Such a process includes causing the unfinished thread 26 to traverse a path between the initial and final spools 22, 24 that allows it to be dipped sequentially into the first, second, and third baths 28, 30, 32, after having been dipped into the second bath 30, to be exposed to the first drier 40 for drying between the second and third bath 30, 32, and, after having been dipped into the third bath 32, to be exposed to the second drier 44 for drying between the third bath 32 and the final spool 24.

The first bath 28 contains the dye that is expected to change color upon exposure to an analyte. The particular dye depends on the particular analyte. The second bath 30 contains a weak acid or base. The third bath 32 contains a polymer. In those embodiments that have more than one polymer coating, there may be additional baths. For example, in some embodiments, the third bath 32 contains contain chitosan and a fourth bath that follows the third bath 32 contains polydimethylsiloxane.

The result of the reel-to-reel dip and dry process executed by the apparatus in FIG. 2 is a thread 18A that has been impregnated with a suitable dye and that has been sealed with a polymer coating.

The response time of a thread 18A to exposure to an analyte decreases as the polymer coating increases thickness. However, the likelihood of leaching decrease with increasing polymer coating thickness. A useful range of coating thickness for a polydimethylsiloxane coating is on the order of 300-500 micrometers.

The combination of washing a weak acid or base and coating with a polymer suppresses leaching and thus permits the sensor 12 to be washed. This protection is usable with a wide variety of dyes, including metalloporphyrin dye.

Having described the invention, and a preferred embodiment thereof, what is claimed as new and secured by Letters Patent is:

1-54. (canceled)

55. An apparatus comprising a wearable sensor having a color that changes in response to exposure to a particular fluid-borne analyte, said wearable sensor comprising threads, wherein said threads are coated with a polymer coating, wherein each of said threads has an optically-responsive chemical dye entrapped thereon, and wherein each of said dyes is selected to change color upon exposure to said particular fluid-borne analyte.

56. The apparatus of claim 55, wherein said threads comprise natural fiber, wherein said dyes comprise a metalloporphyrin, wherein said polymer coating comprises silicone, and wherein said fluid-borne analyte is selected to be ammonia.

57. The apparatus of claim 55, wherein said threads comprise synthetic fiber, wherein said dyes comprise an acid indicator, wherein said polymer coating comprises polyurethane polymer chains, and wherein said fluid-borne analyte is selected to be a sulfur oxide.

58. The apparatus of claim 55, wherein said threads comprise cotton threads, said dyes comprise a base indicator, wherein said polymer coating includes a hydrophobic region, and wherein said fluid-borne analyte is selected to be a nitrogen oxide.

59. The apparatus of claim 55, wherein said threads comprise silk threads, wherein said dyes comprise a metal salt, wherein said polymer coating is intrinsically hydrophobic, and wherein said fluid-borne analyte is selected to be hydrogen chloride.

60. The apparatus of claim 55, wherein said threads comprise wool threads, wherein said dyes comprise a vapochromic substance and wherein said polymer coating is treated to be hydrophobic.

61. The apparatus of claim 55, wherein said threads comprise polyacrylonitrile threads, wherein said threads are treated with an aqueous wash comprising a weak acid and wherein said polymer coating comprises an encapsulating chitosan matrix that coats said threads.

62. The apparatus of claim 55, wherein said threads comprise polyamide threads, wherein said thread is treated with an aqueous wash comprising a weak base.

63. The apparatus of claim 55, wherein said threads comprise polyurethane threads, wherein said threads are treated with an aqueous wash comprising acetic acid.

64. The apparatus of claim 55, wherein said threads comprise polyethylene threads, wherein said polymer coating comprises an encapsulating matrix that coats said threads, thereby entrapping said dyes.

65. The apparatus of claim 55, wherein said threads comprise a polyether-polyurea copolymer threads, wherein said polymer coating comprises a gas permeable polymer.

66. The apparatus of claim 55, wherein said threads include first threads having a first dye and second threads having a second dye, thereby forming a sensor array for gas detection.

67. The apparatus of claim 55, further comprising a garment, wherein said threads are formed into a sensing patch to be sewn on said garment.

68. The apparatus of claim 55, further comprising an accessory, wherein said threads are formed into a sensing patch to be sewn onto said accessory.

69. The apparatus of claim 55, further comprising an accessory, wherein said threads are formed into a sensing patch to be integrated into said accessory, wherein said accessory is selected from the group consisting of a belt, a watch, a wallet, a handkerchief, and a handbag.

70. The apparatus of claim 55, further comprising an interior surface, wherein said threads are formed into a sensing patch to be placed on said interior surface.

71. The apparatus of claim 55, further comprising a device configured to carry out software-based color extraction, said device being configured to receive and process an image of said thread.

72. The apparatus of claim 55, wherein said threads comprise n threads, where n is a positive integer, wherein i is an integer between 1 and n inclusive, wherein the i^{th} thread carries a corresponding i^{th} dye that reacts with a gas from an i^{th} set of gases, wherein said n threads define a sensor array for gas detection, wherein said particular gas is a member of each of said sets of gases, and wherein an extent to which each of said dyes changes color indicates an extent to which said particular gas is likely to be present.

73. A method comprising making a wearable sensor having a color that changes in response to exposure to a particular fluid-borne analyte, said wearable sensor comprising threads, wherein said threads are coated with a polymer coating, wherein each of said threads has an optically-responsive chemical dye entrapped thereon, and wherein each of said dyes is selected to change color upon exposure to said particular fluid-borne analyte, wherein making said sensor comprises causing thread on a first spool to be wound around a second spool after having been dipped into a plurality of baths, said baths comprising a first bath, a second bath, and a third bath, wherein said first bath comprises dye, wherein said second bath comprises one of a weak acid and a weak base, and wherein said third bath comprises a first polymer.

74. The method of claim 73, wherein said baths comprise a fourth bath following said third bath, wherein said fourth bath comprises a polydimethylsiloxane and said third bath comprises chitosan.

75. The method of claim 73, wherein said baths comprise a fourth bath following said third bath, wherein said second bath comprises acetic acid, wherein said first polymer bath comprises polydimethylsiloxane, and wherein said fourth bath comprises a second polymer.
